(19) United States
(12) Patent Application Publication
(10) Pub. No.: US 2022/0173387 A1
(43) Pub. Date: Jun. 2, 2022

(54) CROSS-LINKED CONDUCTIVE POLYMER SHELLS

(71) Applicant: Conamix Inc., Ithaca, NY (US)

(72) Inventors: Christopher A. Simoneau, Trumansburg, NY (US); Stephen Burkhardt, Ithaca, NY (US)

(21) Appl. No.: 17/442,526

(22) PCT Filed: Mar. 25, 2020
(86) PCT No.: PCT/US20/24721

§ 371 Date: Sep. 23, 2021

Related U.S. Application Data
(60) Provisional application No. 62/823,758, filed on Mar. 26, 2019.

(51) Int. Cl. H01M 4/36; H01M 4/62; H01M 4/04

(52) U.S. Cl. CPC H01M 4/366; C08L 79/02; H01M 4/0466; H01M 4/624

(57) ABSTRACT

This application relates to nanostructures, such as nanoparticles, having covalently cross-linked, conductive polymer shells, such as those that may be used as electrode materials for secondary batteries or other energy storage devices, and methods of making same.

### CROSS REFERENCE TO RELATED APPLICATIONS

This application claims priority to and benefit of U.S. application Ser. No. 62/823,758, filed on Mar. 26, 2019, the contents of which is incorporated by reference in its entirety.

### TECHNICAL FIELD

This application relates to nanoparticles having cross-linked conductive polymer shells, such as those that may be used as electrode materials for secondary batteries or other energy storage devices, and methods of making same.

### BACKGROUND

A major objective in commercial development of next generation rechargeable batteries is to provide batteries with higher energy densities and lower cost than state of the art lithium ion batteries. One of the most promising approaches towards achieving this goal relies on use of a sulfur cathode. Sulfur is attractive because it is inexpensive, abundant, and offers a theoretical charge capacity that is an order of magnitude higher than conventional metal oxide-based intercalation cathodes used in current lithium ion cells. However, manufacture of a practical sulfur battery has been an elusive goal. Among the challenges associated with fabrication of sulfur cathodes, some of the most serious arise from: (1) the fact that both sulfur and lithium sulfide are insoluble and electrically insulating; and (2) that polysulfide intermediates formed during battery discharge are highly soluble in electrolyte and difficult to retain at a cathode. The first challenge leads to high impedance and low sulfur utilization, while the second leads to a polysulfide shuttle that decreases battery efficiency and leads to anode fouling.

Thus, although elemental sulfur has been under investigation as a battery cathode material for more than 50 years, certain fundamental challenges have yet to be overcome. To produce a viable cathode material, conductivity of elemental sulfur must first be enhanced. Unlike commercial lithium ion cathodes containing LiCoO₂, which possess a high electronic conductivity and do not require significant addition of conductive additives, sulfur is an insulator, and therefore, in order to prepare a viable and commercially useful battery based on an elemental sulfur cathode, active material must be present in a structure that enhances electrochemical accessibility of sulfur. Attempts to address these challenges have included use of nanoporous and mesoporous monoliths and engineered nanomaterials such as core-shell particles, nanotubes and laminates.

In addition, diffusion and subsequent loss of polysulfide intermediates that are formed during electrochemical cycling must be controlled to produce a viable electrochemical cell. During discharge, sulfur reduces in a stepwise manner by forming a series of polysulfide intermediates which are ionic in nature, dissolve readily in electrolyte, and may be lost by migration to an anode causing mass loss of active material during cycling and anode fouling.

To date, technical approaches taken to address and solve these fundamental challenges have resulted in diminished charge capacity in comparison to the theoretical value of sulfur.

Although incremental improvements in capacity and cycle life have been made, significantly greater improvements in reduction of polysulfide shuttling are needed to produce commercially viable metal-sulfur batteries. Thus, there is a need for a sulfur active material that allows for complete utilization of sulfur while minimizing loss of polysulfides.

Polyaniline is a useful material for encapsulation of sulfur in a cathode of an alkali metal-sulfur battery. Without wishing to be bound by any particular theory, it is believed that a polyaniline encapsulant allows facile flow of lithium ions and good electron conduction, while preventing migration of soluble metal polysulfides into bulk electrolyte where precipitation and migration to a battery anode cause degradation of battery performance. It has previously been shown that performance of such polyaniline encapsulants can be improved by reacting polyaniline with sulfur at elevated temperatures. It is reported that observed improvement is a result of sulfur reacting with aromatic rings of polyaniline forming sulfur cross-linked (e.g., disulfide cross-links) polyaniline chains. However, this process is difficult to control precisely, sulfur linkages may not be stable over time, and/or may be not be electrochemically stable during operation of a battery. As such, there remains a need for improved methods to encapsulate sulfur in battery electrode compositions to improve the energy density of secondary batteries.

An objective of the present disclosure is to provide structured nanomaterials suitable for utilization as a cathode active material which is capable of providing good sulfur utilization while effectively containing soluble polysulfides to prevent their loss or migration.

### SUMMARY

The present disclosure provides, among other things, nanomaterials comprising a covalently cross-linked conductive polymer and an electroactive material comprising electroactive sulfur. As explained in further detail below, use of particular polymers (and modifications thereto), cross-linking chemistries, and methods of nanostructure formation provide improved cathode materials. Further advantages of such cathode materials are explained below and include, for example, improved electron conduction, improved battery performance, and improved battery life.

Generally, use of polymer cross-links disclosed herein promotes changes in a polymer's physical properties, which contribute, at least in part, to structural and performance improvements in batteries or other energy storage devices.

The present disclosure provides, according to one aspect, improved electrode (e.g., cathode) compositions having sulfur encapsulated by conductive polymers that are covalently cross-linked using non-sulfur linkages. Such an approach allows better control of cross-linking density and provides additional flexibility regarding when and how such cross-links are formed. Such an approach further allows for “tuning” or customization of chemical, physical and electronic properties of resulting polymer compositions and performance characteristics of nanomaterials comprising said polymer compositions. Generally, cross-links do not include sulfur-sulfur bonds and do not substantially degrade electronic or lithium ion conductivity of polymer compositions.

In one aspect, the present disclosure provides a core-shell particle having a sulfur-containing composition surrounded by a shell made of a cross-linked conductive polymer. In certain embodiments, a cross-linked conductive polymer is electrically-conducting. In certain embodiments, a cross-linked conductive polymer includes polyaniline. There are a variety of approaches to cross-linking provided polymers that are contemplated and considered within the scope of the invention. In general, any process that creates inter-chain covalent bonds within a conductive polymer composition would be applicable.

Provided cross-linked conductive polymer compositions (and/or the sulfur nanoparticles encapsulated by the polymer compositions) have enhanced performance characteristics relative to conventional compositions. For example, strength and elasticity of a polymer composition can be enhanced; and/or ion and electron conductivity of a polymer composition can be modulated. Such changes to a conductive polymer can enable a thinner coating of polymer to satisfy physical requirements of encapsulation vs. non-cross-linked conductive polymer materials. This in turn can enable higher gravimetric battery capacity and can enhance electrochemical characteristics of nanostructured electrode materials and/or improve their ability to maintain integrity of electrode materials during material processing and battery manufacture or operation. Conventional engineered nanostructures can be physically destroyed by volume changes caused by conversion of sulfur to and from Li₂S during battery charge/discharge since Li₂S occupies an 80% greater volume than an equivalent molar amount of elemental sulfur. Nanostructures comprising provided cross-linked conductive polymer compositions have higher resistance to such physical damage and thus prolong stability of sulfur cathodes.

Additionally, cross-linking can modulate tendencies of polymers to dissolve or swell in processing solvents and electrolyte, thereby improving compatibility of provided electrode materials with processing techniques and with electrolyte systems used in electrochemical cells. Cross-linking of a polymeric shell material can also be used to tune conductivity of said shell, which, in some embodiments, improves rate capability of Li/S cells, for example, by increasing electrical or ion conductivity.

In another aspect, the present disclosure relates to a nanoparticle including a cross-linked conductive polymer shell and an electroactive core disposed within said shell. In some embodiments, a polymer shell comprises a covalently cross-linked polymer.

In another aspect, the present disclosure relates to an electrode for an electrochemical energy storage device, such as a secondary battery, a capacitor, or other electrochemical system. In some embodiments, an electrode includes a nanoparticle as described herein.

In another aspect, the present disclosure relates to an electrochemical energy storage device that includes an anode, a cathode, a separator, and an electrolyte.

In various embodiments of the foregoing aspects, at least one characteristic of a polymer shell (or an entire nanoparticle) is optimized by covalent cross-linking of a conductive polymer as compared to a polymer shell that does not comprise a covalently cross-linked polymer. In some embodiments, at least one characteristic of a shell can include at least one of mechanical strength, elasticity, conductivity, solubility, or swellability, or ability of a nanostructure comprising a polymer to prevent polysulfide shuttling. In some embodiments, optimization includes, for example, an increase in a base value of said characteristic, such as an increase in energy density or mechanical strength of a shell. In some embodiments, optimization includes varying an electrochemical property of a shell to suit a particular application and/or optimizing a combination of characteristics.

Additionally, a cross-linked conductive polymer (CCP) shell defines an interior cavity having a volume. In various embodiments, an electroactive core makes up about 20% to 80% of an interior cavity's volume. This range will vary to suit a particular application and also will vary during operation of an electrode containing these nanoparticles. For example, during charging and discharging, volume of an electroactive core will change.

In some embodiments, a polymer shell includes a conductive polymer. Generally, a polymer can be conductive in various voltage ranges as disclosed below. In some embodiments, a polymer is known to be conductive within a battery's operating voltage window. In some embodiments, a conductive polymer only has good electrical conductivity in a voltage window outside a battery's operative voltage window. Without wishing to be bound by any particular theory, the Applicants believe that in accordance with the present disclosure, polymers that are known to be non-conductive within an operative voltage window for a particular battery may be used to form a polymer shell that sufficiently conducts as part of a nanoparticle described herein. In some cases, a nanoparticle overall is conductive within certain voltage ranges as necessary to suit a particular application. In some embodiments, conductivity of a polymer, shell, and/or complete particle can be measured directly via similar processes and can vary to suit a particular application. In various embodiments, a CCP shell includes a covalently cross-linked polyaniline, although other polymers, such as polyheterocycles, poly-enes, or polyarenes are also contemplated.

In some embodiments, cross-linking of a covalently cross-linked conductive polymer occurs during polymerization, in a post-polymerization process, and/or after forming a nanostructure comprising the polymer. In some embodiments, characteristics of a shell can be controlled by cross-linking a polymer in a doped state or an un-doped state. In certain embodiments, where a shell is cross-linked in a doped state, identity of particular doping salts can further influence properties of a polymer.

In certain embodiments, chemical cross-linking would be preferred, for example, cross-linking a polyaniline by condensation with dialdehydes. In various embodiments, the cross-linking can occur between multivalent (e.g., tri- or higher-valent) co-monomers during polymer synthesis. For example, triphenylamine and/or paraphenylene diamine can be incorporated as co-monomers during polyaniline synthesis.

In some embodiments, cross-linking occurs between functional groups located on co-monomers introduced during polymer synthesis. In some cases, a covalently cross-linked conductive polymer includes an inter-polymer chain cross-linker, such as a cross-linker formed when a suitable cross-linking agent reacts with two or more polymer chains to form one or more covalent bonds. In some embodiments, a cross-linker is derived from a reaction of polymer chains (e.g., polyaniline) with a cross-linking reagent such as a dichlorohydrocarbon (e.g., α, α′-dichloro-p-xylene); a dialdehyde (e.g., glutaraldehyde); or a diisocyanate (e.g. toluene diisocyanate). In certain embodiments, a cross-linker does not include sulfur atoms. In certain embodiments, a cross-linker does not include sulfur-sulfur bonds. In certain embodiments, interchain covalent bonds are other than those formed by sulfur atoms e.g. by vulcanization.

In various embodiments of nanoparticles disclosed herein, a shell has a dimension (e.g., diameter or length) of about 20 to about 1000 nanometers (nm), about 100 to about 900 nm, about 200 to about 800 nm, or about 400 to about 800 nm and a wall thickness of about 5 to about 50 nm to suit a particular application. In some embodiments, a nanoparticle is substantially spherical, a nanowire, or a plate; however, other shapes (e.g., ovoids, ellipsoids or polyhedral, or combinations thereof) are contemplated and considered within the scope of the present disclosure. In some embodiments, a shell includes two or more layers that, in some instances, have the same compositions, and in some instances, have different compositions. In some embodiments, a shell or complete nanoparticle includes one or more additives.

The foregoing aspects, along with advantages and features of disclosed systems and methods, will become apparent through reference to the following description and accompanying drawings. Furthermore, it is to be understood that features of various embodiments described are not mutually exclusive and can exist in various combinations and permutations.

### DEFINITIONS

In order for the present disclosure to be more readily understood, certain terms are first defined below. Additional definitions for the following terms and other terms are set forth throughout the specification.

In this application, unless otherwise clear from context, the term “a” may be understood to mean “at least one.” As used in this application, the term “or” may be understood to mean “and/or.” In this application, the terms “comprising” and “including” may be understood to encompass itemized components or steps whether presented by themselves or together with one or more additional components or steps. As used in this application, the term “comprise” and variations of the term, such as “comprising” and “comprises,” are not intended to exclude other additives, components, integers or steps.

About, Approximately: As used herein, the terms “about” and “approximately” are used as equivalents. Unless otherwise stated, the terms “about” and “approximately” may be understood to permit standard variation as would be understood by those of ordinary skill in the art. Where ranges are provided herein, endpoints are included. Any numerals used in this application with or without about/approximately are meant to cover any normal fluctuations appreciated by one of ordinary skill in the relevant art. In some embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would be less than 0%, or would exceed 100% of a possible value).

Electroactive Substance: As used herein, the term “electroactive substance” refers to a substance that changes its oxidation state, or partakes in a formation or breaking of chemical bonds, in a charge-transfer step of an electrochemical reaction.

Polymer: As used herein, the term “polymer” generally refers to a substance that has a molecular structure consisting chiefly or entirely of repeated sub-units bonded together, such as synthetic organic materials used as plastics and resins.

Nanostructure, Nanomaterial: As used herein, these terms may be used interchangeably to denote a composition with sub-micrometer features. Such materials can have essentially any shape or configuration, such as a tube, a wire, a laminate, sheets, lattices, a box, a core and shell, or combinations thereof.

Nanoparticle: As used herein, refers to a discrete particle with at least one dimension having sub-micron dimensions.

Substantially: As used herein, the term “substantially” refers to the qualitative condition of exhibiting total or near-total extent or degree of a characteristic or property of interest.

### BRIEF DESCRIPTION OF THE DRAWINGS

In the drawings, like reference characters generally refer to the same parts throughout the different views. Also, the drawings are not necessarily to scale, emphasis instead generally being placed upon illustrating principles of disclosed compositions and methods and are not intended as limiting. For purposes of clarity, not every component may be labeled in every drawing. In the following description, various embodiments are described with reference to the following drawings, in which:

FIG. 1 is a pictorial representation of a nanostructure in accordance with one or more embodiments of the present disclosure;

FIG. 2A, 2B, and 2C are pictorial representations of alternative nanostructures in accordance with one or more embodiments of the present disclosure;

FIGS. 3A, 3B, and 3C are pictorial representations of a fabrication process for a nanostructure in accordance with one or more embodiments of the present disclosure;

FIG. 4 is a pictorial representation of a portion of an electrode made up of nanostructures in accordance with one or more embodiments of the present disclosure;

FIG. 5 is a pictorial representation of an electrical storage device during a discharging cycle in accordance with one or more embodiments of the present disclosure; and

FIG. 6 is a schematic representation of an exemplary electrochemical cell in accordance with one or more embodiments of the present disclosure.

### DETAILED DESCRIPTION

Generally, the present disclosure is directed to nanostructured materials for use in energy storage devices and related methods for fabricating such materials. Provided nanostructured materials are useful for example in manufacture of electrodes. Such electrodes have utility in energy storage devices, such as secondary batteries (e.g., a lithium-sulfur battery), capacitors, and other electrochemical devices.

I. Nanostructured Materials

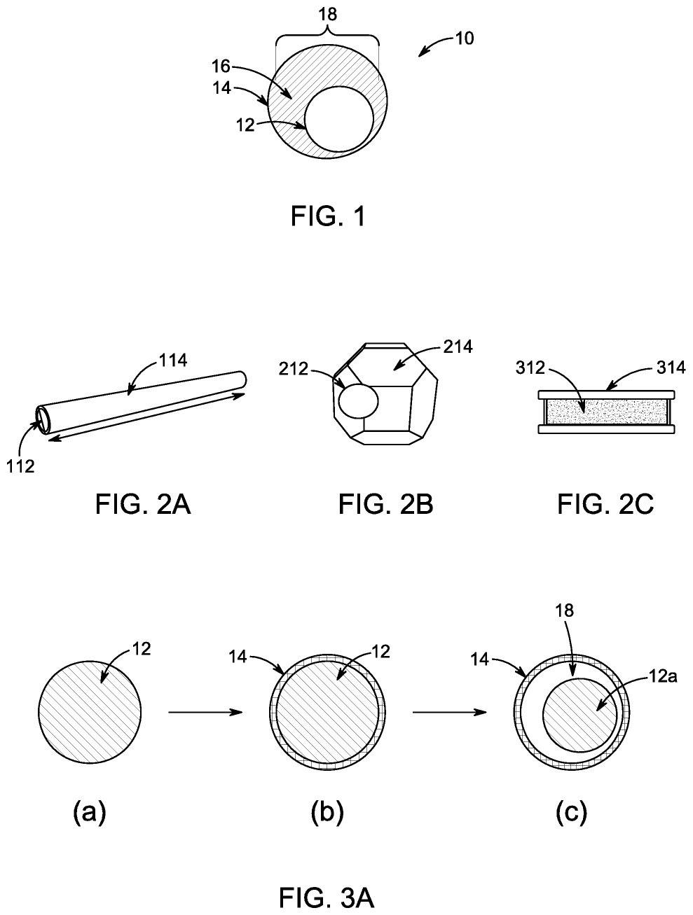

Nanostructured materials of the present disclosure are not limited to any specific morphology. Provided nanostructured materials may take various forms, a few non-limiting examples of which are illustrated in FIGS. 1, 2A, 2B, and 2C. In certain embodiments, nanostructured materials comprise core-shell nanoparticles, wherein a conductive crosslinked polymer (CCP) forms a shell surrounding a core comprising an electroactive substance(s). In certain embodiments, nanostructured materials comprise yolk-shell nanoparticles, wherein a CCP forms a shell surrounding a volume containing a smaller ‘yolk’ comprising an electroactive substance(s) (FIG. 1). In certain embodiments, nanostructured materials comprise a porous matrix of CCP, wherein an electroactive substance is disposed within pores of a matrix. In certain embodiments, nanostructured materials comprise nanowires (FIG. 2A), wherein a CCP comprises a substantially cylindrical structure containing an electroactive substance(s) within. In certain embodiments, nanostructured materials comprise layered structures containing one or more layers of an electroactive substance(s) alternating with one or more layers of CCP (FIG. 2C). In certain embodiments, nanostructured materials comprise complex structures containing one or more arcuate and/or polygonal shapes (FIG. 2B). In any of such nanostructures, portions of such a nanostructure comprising CCP (e.g. shell, matrix, layer, etc.), may consist entirely of CCP, or may comprise CCP along with additional materials. Such additional materials may be present in various forms, for example: additional materials can be present as discrete layers contained within or disposed upon CCP (e.g. in a multilayer shell); in some embodiment, additional materials are present as mixtures intimately mixed or compounded with CCP; in some embodiments, additional materials are present in composites with CCP. Suitable additional materials that may be present with CCP include other polymers, elemental carbon, metallic elements or their alloys, metal oxides, metal chalcogenides, metal salts, ceramics, glasses, clays, semiconductors, and the like, as described more fully in embodiments and definitions provided herein.

In certain embodiments, provided nanostructured materials are characterized in that an electroactive substance is in a form having nanometer dimensions. In certain embodiments, an electroactive substance is present in a form having at least one dimension with a length in a range of about 5 to about 1,000 nm. In certain embodiments, an electroactive substance is present in a form having at least one dimension with a length in a range of about 10 to about 50 nm, about 30 to about 100 nm, about 100 to about 500 nm, or about 500 to about 1,000 nm.

In certain embodiments, nanostructured materials are characterized in that CCP composition is present in a form having nanometer dimensions. In certain embodiments, a CCP composition is present in a form having at least one dimension with a length in a range of about 5 to about 1,000 nm. In certain embodiments, a CCP composition is present in a form having at least one dimension with a length in a range of about 5 to about 10 nm, about 10 to about 50 nm, about 30 to about 100 nm, about 100 to about 500 nm, or about 500 to about 1,000 nm. In certain embodiments, a CCP composition is present in a three-dimensional form characterized in that one dimension (i.e. thickness) is substantially smaller than the other two dimensions, examples of these forms include, sheets, shells, platelets, tubes, coatings and the like. In certain embodiments, such compositions are characterized in that they have a smallest dimension (e.g. thickness) less than about 50 nm. In certain embodiments, a CCP composition is present in a sheet-like form or a shell having a thickness between about 1.5 and about 5 nm, between about 5 and about 10 nm, between about 5 and about 25 nm, between about 10 and about 40 nm or between about 25 and about 50 nm.

In certain embodiments, the present disclosure provides compositions comprising nanostructured materials with consistent morphological features. Such compositions are distinct from, and have performance advantages relative to, polydispersed mixtures that may randomly contain individual particles having nanostructural features described herein. In certain embodiments, the present disclosure provides compositions comprising nanostructured particles with a narrow size distribution. In certain embodiments, the present disclosure provides compositions comprising nanostructured particles with a high level of morphological homogeneity. In certain embodiments, these characteristics are assessed by direct observation (e.g., electron microscopy) or by measuring particle size distribution using light scattering or similar techniques known in the art.

In certain embodiments, nanostructured materials of the present disclosure comprise core-shell nanoparticles. Such core-shell particles comprise an electroactive core surrounded by a shell comprising a conductive cross-linked polymer. In certain embodiments, such core-shell particles are characterized in that an electroactive core occupies only a portion of volume contained by a shell. Such architecture is sometimes referred to as “yolk-shell” and is valuable for electroactive materials that undergo substantial volume changes during charge and discharge. In certain such embodiments, nanostructured materials of the present disclosure comprise core-shell nanoparticles characterized in that an electroactive core occupies less than about 80% of an internal volume contained by a shell. In certain embodiments, such compositions are characterized in that an electroactive core occupies less than about 75%, less than about 60%, or less than about 50% of an internal volume defined by a shell. In certain embodiments, nanostructured materials of the present disclosure comprise core-shell nanoparticles characterized in that an electroactive core occupies between about 30 and about 80% of an internal volume contained by a shell. In certain embodiments, such compositions are characterized in that an electroactive core occupies between about 30 and about 50%, between about 40 and about 65%, between about 50 and about 75% or between about 60 and about 80% of an internal volume defined by a shell.

II. Cross-linked Conductive Polymer Compositions

As described above, nanostructured compositions of the present disclosure are characterized by incorporation of conductive cross-linked polymers. It has been found that by using particular approaches to covalently cross-link polymers, performance of energy storage devices utilizing resulting structured nanomaterials can be improved. In certain aspects, provided CCP compositions have improved stability relative to prior art polymers that are cross-linked through vulcanization. In certain embodiments, provided CCPs are more stable to conditions encountered during operation of electrochemical storage devices than are prior art cross-linked polymers that contain sulfur-sulfur bonds. Without being bound by theory or thereby limiting the scope of the present disclosure, it is believed that cross-links comprising sulfur-carbon or sulfur-sulfur linkages are electrochemically unstable and that nanostructured materials comprising polymers containing such cross-links are prone to changes in their physical structures and/or diminution of their performance characteristics during normal operation of electrochemical devices. In contrast, provided nanostructured compositions contain polymers having electrochemically stable covalent cross-links that increase structural stability of provided nanostructured materials during electrochemical cycling and thereby improve key properties linked to performance of energy storage devices incorporating such materials.

It has also been found that by using particular approaches to covalently cross-link polymers, manufacturability of structured nanomaterials can be improved. The inventors have observed that thermal treatment processes (e.g. vulcanization processes) necessary to produce prior art sulfur cross-linked polymers are difficult to control. These processes also present manufacturing challenges that lead to undesirable changes in nanostructured materials. For example, vulcanizing structured nanomaterials at high temperatures sometimes causes sintering, fusing, or deformation of nanoparticles and these processes (or subsequent steps then required to convert sintered products into powders suitable for further processing) can alter or destroy morphology of nanostructured materials in undesirable ways. Additionally, thermal crosslinking with sulfur can cause migration of sulfur to areas of a nanostructure where it is not wanted (e.g. sulfur migration to the outer surfaces of core-shell particles, or out of the pores or interstitial spaces of matrix or layered structures), resulting in undesirable effects on battery performance and also making it difficult to control degree and/or distribution of cross-linking.

Against this backdrop, the present disclosure provides improved nanostructured materials comprising conductive polymer compositions that feature stable covalent cross-links between polymer chains. In certain embodiments, CCPs feature monomer units comprising heterocycles or hetero-substituted aromatic moieties. Non-limiting examples of suitable conductive polymers based on heterocyclic monomers include polypyrrole (PPy), polythiophene (PTh), polydopamine, poly(3,4-ethylenedioxythiophene) (PEDOT), poly(3,4-propylenedioxythiophene) (ProDOT), poly(3,4-ethylenedioxypyrrole) (PEDOP), poly(3,4-propylenedioxypyrrole) (ProDOP), poly(3,4-ethylenedithiopyrrole) (PEDTP), poly(3,4-ethyleneoxyhiathiophene) (PEOTT), poly(3,4-ethylenedioxyselenophene) (PEDOSe). Non-limiting examples of polymers based on hetero-substituted aromatic monomers include: polyaniline (PAni), poly(o-methylaniline) (POTO), poly(o-methoxyaniline) (POAS), poly(2,5-dimethylaniline) (PDMA), poly(2,5-dimethoxyaniline) (PDOA), sulfonated polyaniline (SPAN), poly(1-aminonaphthalene) (PNA), poly(5-aminonaphthalene-2-sulfonic acid) and polyphenylene sulfide. In certain embodiments, provided cross-linked conductive polymer compositions comprise copolymers, mixtures, or composites comprising two or more of materials described above.

In certain embodiments, CCP comprises polyaniline (PAni) or derivatives thereof. While descriptions below largely focus on PAni as the conductive polymer, it is to be understood that PAni is merely representative and that concepts presented herein with respect to this polymer can also be applied or adapted to other conductive polymer compositions using knowledge within grasp of a skilled chemist or polymer scientist.

As mentioned above, thermally cross-linked and vulcanized PAni compositions have been previously utilized in cathode materials for secondary batteries. It is asserted by prior researchers that thermal treatment of PAni in the presence of elemental sulfur results in formation of sulfur-carbon linkages in a polymer (vulcanization) additionally, it is possible that thermal cross-linking of PAni via intramolecular aromatic substitution by enchained nitrogen atoms to form pyrazine rings and related structures may also occur. These processes are difficult to control and, in thermal cross-linking, for example, leads to shrinkage of polymer and a loss of porosity that, in some instances, is not desirable for nanostructured cathode compositions. Similar detriments are encountered during vulcanization and thermal cross-linking processes in other conductive polymers.

In some embodiments, the present disclosure provides solutions to these problems by providing improved nanostructured electroactive materials featuring polymer compositions with controlled chemical cross-linking. In some embodiments, provided cross-linked conductive polymer compositions are categorized into several classes:

a) Polymer compositions that are crosslinked during polymerization;

b) Polymer compositions that are cross-linked by post polymerization processes; and

c) Polymer compositions resulting from hybrid approaches that rely on incorporation of functional groups during a polymerization step for the express purpose of enabling formation of covalent cross-links during a subsequent post-polymerization process.

Polymer compositions that are crosslinked during polymerization

In certain embodiments, the present disclosure provides nanostructured compositions comprising cross-linked conductive polymers that feature covalent cross-links formed during a polymerization step. In some embodiments, polymers are obtained by performing a polymerization or oligomerization step in the presence of polyfunctional co-monomers. In certain embodiments, polyfunctional co-monomers have structures that result in cross-links that do not interrupt electrical conductivity of a polymer network.

In the case of polyaniline—which is typically synthesized from aniline in the presence of chemical oxidants or via electrochemical oxidation—suitable polyfunctional co-monomers include: triphenylamine (TPA), p-phenylene diamine (PPD), various aniline dimers or oligomers, particularly those linked via carbon atoms ortho to the aniline —NH₂ group, (e.g. aniline-formaldehyde oligomers), and combinations thereof. The presence of PPD/TPA as comonomers in polyaniline synthesis leads to cross-links of the following structure:

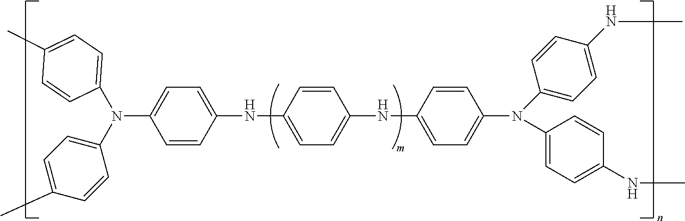

where m and n are independently ≥1. The presence of aniline-formaldehyde oligomers leads to structures conforming to:

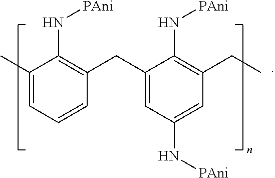

In some embodiments, density of cross-links in provided polymer compositions are controlled to modulate properties and performance characteristics of provided nanostructured materials. For polymers formed by co-polymerization with polyfunctional cross-link forming monomers, density of cross-linking can be controlled by changing molar ratio of such cross-linking monomers to difunctional linear monomers. In certain embodiments, relatively light cross-linking is desirable; e.g., where flexibility is desired and very high tensile strength or solvent resistance of CCP is less critical. In other situations, higher cross-link densities may be desirable; e.g., where polymer flexibility is less critical, but high mechanical strength or high resistance to solvent swelling during processing or utilization is important. Cross-link density of suitable polymers advantageously ranges from about 0.01 mol % to about 20 mol % enchained cross-linking monomer units relative to linear monomer units enchained in a polymer.

In certain embodiments, nanostructured compositions of the present disclosure comprise lightly cross-linked conductive polymer compositions containing between about 0.05 mol % and about 2 mol % enchained cross-linking monomer units relative to linear monomer units enchained in a polymer. In certain embodiments, nanostructured compositions of the present disclosure comprise CCP compositions containing between about 0.05 mol % and about 0.1 mol %, between about 0.1 mol % and about 0.5 mol %, between about 0.5 mol % and about 1 mol %, or between about 1 mol % and about 2 mol % enchained cross-linking monomer units relative to linear monomer units enchained in a polymer.

In certain embodiments, nanostructured compositions of the present disclosure comprise moderately cross-linked conductive polymer compositions containing between about 0.5 mol % and about 5 mol % enchained cross-linking monomer units relative to linear monomer units enchained in a polymer. In certain embodiments, nanostructured compositions of the present disclosure comprise CCP compositions containing between about 0.5 mol % and about 1 mol %, between about 1 mol % and about 2.5 mol %, or between about 2.5 mol % and about 5 mol % enchained cross-linking monomer units relative to linear monomer units enchained in a polymer.

In certain embodiments, nanostructured compositions of the present disclosure comprise heavily cross-linked conductive polymer compositions containing between about 5 mol % and about 20 mol % enchained cross-linking monomer units relative to linear monomer units enchained in a polymer. In certain embodiments, nanostructured compositions of the present disclosure comprise CCP compositions containing between about 5 mol % and about 7 mol %, between about 7 mol % and about 10 mol %, between about 10 mol % and about 15 mol %, or between about 15 mol % and about 20 mol % enchained cross-linking monomer units relative to linear monomer units enchained in a polymer.

In some embodiments, molar percentage of enchained cross-linking monomer units relative to other enchained monomer units are measured in a polymer composition by spectroscopic analysis of a polymer by known methods—for example, utilizing techniques such as nuclear magnetic resonance spectroscopy or infrared spectroscopy to measure intensity of spectroscopic signals associated with cross-links. In some embodiments, mole percent of enchained cross-linking monomer units refers to a value determined by standard techniques relying on solvent swelling measurements (e.g. ASTM D2765 or F2214). Alternatively, in certain embodiments, mole percent of enchained cross-linking monomer units is inferred from knowledge of monomer feed ratios utilized in a polymerization process, or by other means known in the art.

In certain embodiments, nanostructured compositions of the present disclosure comprise cross-linked polyaniline compositions containing between about 0.05 mol % and about 20 mol % cross-linking monomer units relative to linear aniline units in a polymer. In certain embodiments, nanostructured compositions of the present disclosure comprise cross-linked polyaniline compositions containing between about 0.05 mol % and about 0.5 mol %, between about 0.5 mol % and about 1 mol %, between about 1 mol % and about 2 mol %, between about 2 mol % and about 5 mol %, between about 5 mol % and about 10 mol %, or between about 10 mol % and about 20 mol % cross-linking monomer units relative to aniline monomer units in a polymer composition.

In certain embodiments, nanostructured compositions of the present disclosure comprise cross-linked polyaniline compositions containing between about 0.05 mol % and about 20 mol % TPA-derived monomer units relative to total linear (e.g., aniline) units in a polymer. In certain embodiments, nanostructured compositions of the present disclosure comprise cross-linked polyaniline compositions containing between about 0.05 mol % and about 0.5 mol %, between about 0.5 mol % and about 1 mol %, between about 1 mol % and about 2 mol %, between about 2 mol % and about 5 mol %, between about 5 mol % and about 10 mol %, or between about 10 mol % and about 20 mol % TPA monomer units relative to total linear (e.g., aniline) monomer units in a polymer composition.

In certain embodiments, nanostructured compositions of the present disclosure comprise cross-linked polyaniline compositions containing between about 0.05 mol % and about 20 mol % PPD monomer units relative to linear aniline units in a polymer. In certain embodiments, nanostructured compositions of the present disclosure comprise cross-linked polyaniline compositions containing between about 0.05 mol % and about 0.5 mol %, between about 0.5 mol % and about 1 mol %, between about 1 mol % and about 2 mol % , between about 2 mol % and about 5 mol %, between about 5 mol % and about 10 mol %, or between about 10 mol % and about 20 mol % PPD monomer units relative to aniline monomer units in a polymer.

For applications described herein, distribution of cross-links in provided conductive polymer compositions may be important in modulating performance characteristics. In certain embodiments, spatial distribution of cross-links in polymer chains are controlled. In certain embodiments, spatial distribution is controlled by first synthesizing oligomers of a linear monomer (e.g., aniline) to form linear chains of a desired length (e.g., oligomers in a range of a few repeat units to small polymers containing up to about 50 repeat units) prior to introducing polyfunctional monomers. In certain embodiments, this process is performed in one pot without isolation of linear oligomers prior to reaction with cross-linking monomers. In some embodiments, it is advantageous or convenient to produce and isolate linear oligomers prior to feeding them into a polymerization containing cross-linking monomers.

Post-polymerization cross-linking approaches

In certain embodiments, provided cross-linked conductive polymer compositions contain cross-links formed by treating a polymer composition with a cross-linking agent in a post-polymerization process. In principle, any molecule capable of forming two or more covalent bonds to polymer chains in the composition can be utilized to make such polymer compositions. A wide range of di- and poly-functional cross-linking reagents are known in the art, and the skilled artisan can readily select suitable cross-linking agents for a given polymer based on knowledge of chemical reactivity and literature precedents.

Again, taking polyaniline as an example, suitable approaches include condensation reactions of nitrogen atoms in PAni chains with suitable functional groups such as aldehydes, ketones, carboxylic acids, and derivatives of these such as acetals, ketals, esters, acid chlorides and the like. In the case of aldehydes and ketones, each carbonyl functional group can condense with two nitrogen atoms thereby creating potential inter-chain cross-links. When a carboxylic acid or derivative is utilized, cross-linking requires use of a di- or polyacid (or related derivative). Dialdehydes condense to react with up to four nitrogen atoms as shown below.

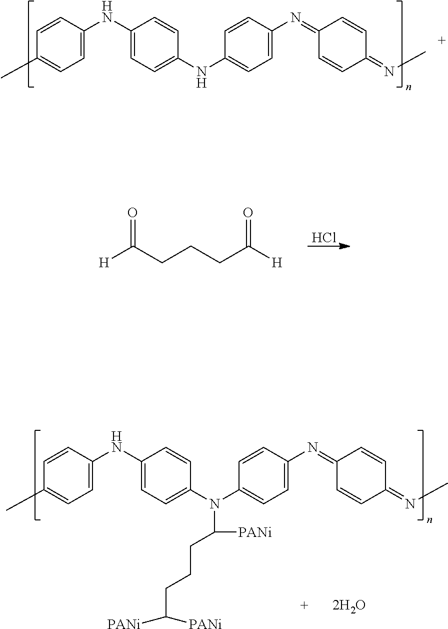

In certain embodiments, nanostructured compositions of the present disclosure comprise polyaniline cross-linked by reaction with an aldehyde in a post-polymerization step. Such polymers can contain crosslinks conforming to:

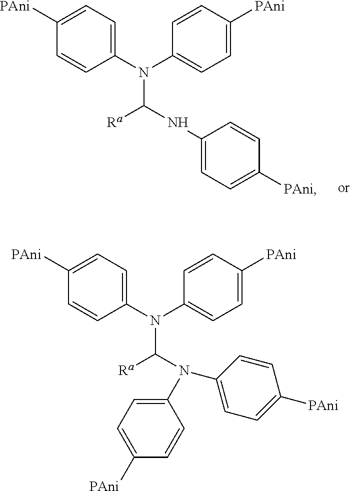

where R^{a} represents a residue derived from an aldehyde of formula R^{a}CHO.

In certain embodiments, nanostructured compositions of the present disclosure comprise polyaniline cross-linked by reaction with a mono-aldehyde. In certain embodiments, an aldehyde is a C1 to C6 aliphatic aldehyde. In certain embodiments, an aldehyde is a C1-4 aliphatic aldehyde. In certain embodiments, an aldehyde is selected from formaldehyde, acetaldehyde, propionaldehyde, and n-butyl aldehyde. In certain embodiments, an aldehyde is an optionally substituted aromatic aldehyde. In certain embodiments, an aldehyde is benzaldehyde.

In certain embodiments, nanostructured compositions of the present disclosure comprise polyaniline cross-linked by reaction with a di-aldehyde. In certain embodiments, a dialdehyde is a C3 to C8 aliphatic di-aldehyde. In certain embodiments, an aldehyde is glutaraldehyde.

In certain embodiments, nanostructured compositions of the present disclosure comprise polyaniline cross-linked by reaction with a diacid, a diester, or a diacid chloride. Such polymers contain substructures conforming to:

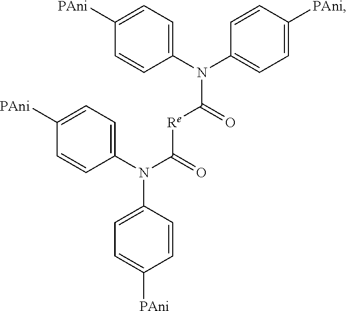

where R^{e} represents a residue derived from a diacid, diester, di acid chloride of formula XO₂C(R^{e})CO₂X where X is —H, an optionally substituted carbon atom, or a halide.

A similar post-polymerization cross-linking approach comprises reacting PAni with di- or poly-electrophiles such as dihalides, or bis-sulfonate esters. Such electrophiles react with PAni nitrogen atoms to form covalent cross-links. A wide range of suitable polyfunctional electrophiles are known in the art and may be utilized for this purpose. Shown below is an example of cross-linking of PAni by reaction with α,α′ dichlorop-xylene.

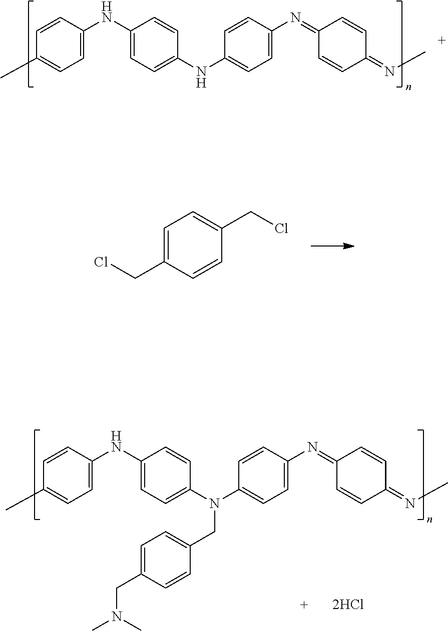

A similar post-polymerization cross-linking approach comprises reacting PAni with curing agents such as polyisocyanates or polyepoxides (e.g. diisocyanates, diepoxides and the like) commonly used to make thermoset polymers. Such cross-linking agents react with PAni nitrogen atoms to form covalent cross-links such as urea or amine linkages. The scheme below demonstrates use of toluene diisocyanate to form urea cross-links in polyaniline.

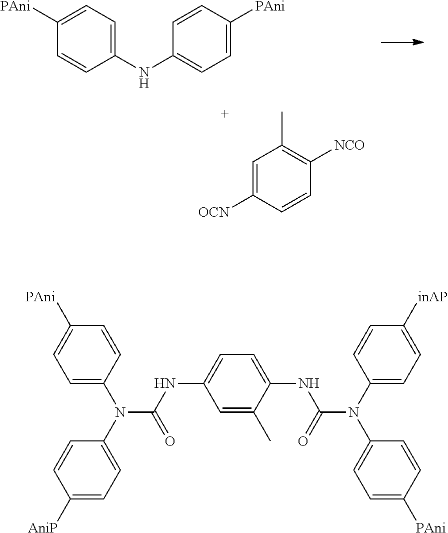

In certain embodiments, where polymers are formed by post-polymerization reaction of polymers with polyfunctional cross-link forming reagents, density of cross-linking is controlled by modulating molar ratio of a cross-linking reagent to polymer repeat units. In certain embodiments, relatively light cross-linking is desirable; e.g., where polymer flexibility is desired and very high tensile strength or solvent resistance is less critical. In other situations, higher cross-link densities are desirable; e.g., where flexibility is less critical, but high mechanical strength or high resistance to solvent swelling during processing or utilization is important. In some embodiments, cross-link density of suitable polymers advantageously ranges from about 0.01 mol % to about 20 mol % cross-links relative to linear monomer units enchained in a polymer composition.

In certain embodiments, nanostructured compositions of the present disclosure comprise lightly cross-linked conductive polymer compositions containing between about 0.01 mol % and about 2 mol % enchained monomer units participate in cross-links. In certain embodiments, nanostructured compositions of the present disclosure comprise cross-linked conductive polymer compositions containing between about 0.01 mol % and about 0.05 mol %, between about 0.05 mol % and about 0.1 mol %, between about 0.1 mol % and about 0.5 mol %, between about 0.5 mol % and about 1 mol %, or between about 1 mol % and about 2 mol % of monomer units enchained in a polymer comprise cross-links.

In certain embodiments, nanostructured compositions of the present disclosure comprise moderately cross-linked conductive polymer compositions wherein between about 0.5 mol % and about 5 mol % enchained monomer units contain cross-links. In certain embodiments, nanostructured compositions of the present disclosure comprise CCP compositions wherein between about 0.5 mol % and about 1 mol %, between about 1 mol % and about 2.5 mol %, or between about 2.5 mol % and about 5 mol % of monomer units enchained in a polymer comprise cross-links.

In certain embodiments, nanostructured compositions of the present disclosure comprise heavily cross-linked conductive polymer compositions, wherein between about 5 mol % and about 20 mol % of enchained monomer units contain cross-links. In certain embodiments, nanostructured compositions of the present disclosure comprise CCP compositions, wherein between about 5 mol % and about 7 mol %, between about 7 mol % and about 10 mol %, between about 10 mol % and about 15 mol %, or between about 15 mol % and about 20 mol % of enchained monomer units comprise cross-links.

In some embodiments, mole percentage of enchained cross-linking monomer units relative to other enchained monomer units is ascertained in a cross-linked conductive polymer composition by spectroscopic analysis of a polymer by known methods—for example, utilizing methods such as nuclear magnetic resonance spectroscopy or infrared spectroscopy. In some embodiments, mole percent of crosslinks refers to a value measured by standard techniques relying on solvent swelling characteristics (e.g. ASTM D2765 or F2214). Alternatively, in some embodiments, mole percent of crosslinking is inferred from knowledge of molar ratio of cross-linking agent utilized in a post-polymerization process, or by other means well known in the art.

Hybrid cross-linking approaches

In certain embodiments, provided cross-linked conductive polymer compositions contain cross-links formed by incorporating functional groups during a polymerization step and subsequently treating a polymer composition in a post-polymerization process to effect cross-linking through introduced functional groups. In principle, a wide range of chemistries can be utilized to make such polymer compositions. A primary requirement is that functional groups introduced during a polymerization stage do not interfere with or participate in a polymerization process and that those groups be reactive under post-polymerization conditions that do not degrade a polymer.

Examples of such functional groups include olefins, alcohols, amines, esters, azides, epoxides, and the like. To take but one example, it has been reported that introduction of an azido group during polymerization of PAni followed by a post polymerization reaction can lead to crosslinked PAni:

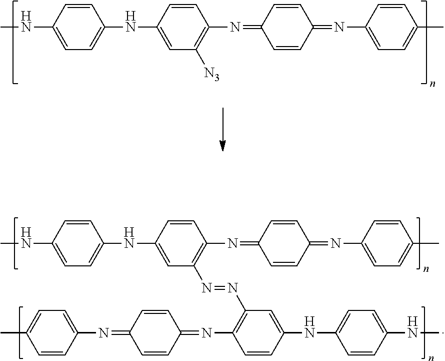

Other related examples include incorporation of aliphatic amino groups during polymerization followed by post-polymerization reaction with epoxides to form cross-links; incorporation of aliphatic amino or hydroxyl groups during polymerization followed by post-polymerization reaction with isocyanates; and incorporation of alkene groups during polymerization followed by post-polymerization olefin metathesis.

III. Electroactive Core Compositions

In some embodiments, in addition to a cross-linked conductive polymer, nanostructured materials of the present disclosure comprise an electroactive substance. In some embodiments, an electroactive substance is preferably in a form having nanometer dimensions. In certain embodiments, an electroactive substance is present in a form having at least one dimension with a length in a range of about 5 to about 1,000 nm. In certain embodiments, an electroactive substance is present in a form having at least one dimension with a length in a range of about 10 to about 50 nm, about 30 to about 100 nm, about 100 to about 500 nm, or about 500 to about 1,000 nm. In certain embodiments, an electroactive substance is present in a form having at least one dimension with a length in a range of about 400 to about 1,000 nm.

In certain embodiments, provided nanostructured materials have utility as cathode compositions for sulfur batteries. In certain embodiments, such compositions comprise an electroactive sulfur-based material. Examples of suitable electroactive sulfur-based materials include elemental sulfur, sulfur composites, sulfur-containing organic molecules, sulfur-containing polymers, metal sulfides as well as combinations or composites of two or more of these.

In certain embodiments, an electroactive sulfur is present in the form of elemental sulfur. In certain embodiments, an electroactive sulfur material comprises Ss. In certain embodiments, an electroactive sulfur material comprises a composite of carbon and elemental sulfur. In certain embodiments, an electroactive sulfur material comprises a sulfur-containing polymer.

In certain embodiments, an electroactive sulfur is present as a metal sulfide. In certain embodiments, a metal sulfide comprises an alkali metal sulfide; in certain embodiments, a metal sulfide comprises lithium sulfide.

In certain embodiments, an electroactive sulfur material is present as a composite with another material. Such composites may include conductive additives such as graphite, graphene, carbon nanotubes, metal sulfides or metal oxides, or conductive polymers. In certain embodiments, sulfur may be alloyed with other chalcogenides such as selenium, tellurium or arsenic.

Generally, dimensions and shape of an electroactive sulfur-based material in a cathode composition may be varied to suit a particular application and/or may be dictated or a consequence of morphology of a nanostructure comprising a conductive cross-linked polymer composition. In various embodiments, an electroactive sulfur-based material is present as a nanoparticle. In certain embodiments, such electroactive sulfur-based nanoparticles have a spherical or spheroid shape. In certain embodiments, nanostructured materials of the present disclosure comprise substantially spherical sulfur-containing particles with a diameter in a range of about 50 to about 1,200 nm. In certain embodiments, such particles have a diameter in a range of about 50 to about 250 nm, about 100 to about 500 nm, about 200 to about 600 nm, about 400 to about 800 nm or about 500 to about 1,000 nm.

In certain embodiments, such electroactive sulfur-based nanoparticles have a rhomboid or polyhedral shape. In certain embodiments, nanostructured materials of the present disclosure comprise substantially rhomboid or polyhedral particles with a major dimension in a range of about 50 to about 1,200 nm. In certain embodiments, such particles have a major dimension in a range of about 50 to about 250 nm, about 100 to about 500 nm, about 200 to about 600 nm, about 400 to about 800 nm or about 500 to about 1,000 nm.

Such electroactive sulfur-based nanoparticles may comprise a component of nanostructures that have various morphologies as described above. In certain embodiments, an electroactive sulfur-based material is present as a core of a core-shell particle, where it is surrounded by a cross-linked conductive polymer shell. In certain embodiments, such core-shell particles may comprise yolk-shell particles as described above.

IV. Cathode Mixtures

Generally, in some embodiment, nanostructures disclosed herein are used to produce cathodes. Cathode production typically involves applying a uniform layer of a cathode mixture onto a current conductor such a metal foil or conductive carbon sheet. In certain embodiments, the present disclosure provides cathode mixtures that are useful for producing and manufacturing cathodes for batteries or other electrochemical devices. Provided cathode mixtures include nanostructured materials according to embodiments and examples herein (e.g., nanowires, core-shell particles, etc.) optionally mixed with additional materials such as electrically conductive additives, binders, surfactants, stabilizers, wetting agents and the like. Such mixtures are typically provided in the form of fine powders that can applied by techniques such as slurry coating or roll-to-roll processing. Cathode mixtures typically comprise relatively larger quantities of materials than materials made for experimental evaluation and it can be non-trivial to produce nanostructured materials with consistent characteristics in large batches. In certain embodiments, cathode mixtures of the present disclosure are characterized in that they comprise a homogenous sample with a quantity greater than about 100 grams (g), greater than about 1 kilogram (kg), greater than about 10 kg, greater than about 100 kg, or greater than about 1 ton.

In some embodiments, additional materials are included with nanostructured materials to alter or otherwise enhance provided cathode mixtures produced from a mixture. Generally, provided cathode mixtures will contain nanoparticles in a proportion ranging from about 50 wt. % to about 98 wt. %, preferably about 60 wt. % to about 95 wt. %, and more preferably about 75 wt. % to about 95 wt. % of total cathode mixture.

In certain embodiments, cathode mixtures comprising provided nanoparticles contain at least 50 wt. % sulfur relative to all components in a cathode mixture. In certain embodiments, provided cathode mixtures are characterized in that they have a high sulfur content. In certain embodiments, provided cathode mixtures are characterized in that they contain above 60 wt. %, above 65 wt. %, above 70 wt. %, above 75 wt. %, above 80 wt. %, above 85 wt. %, or above 90 wt. % sulfur relative to total cathode mixture.

In certain embodiments, provided nanostructured materials are mixed with electrically conductive particles (e.g., conductive carbon, such as carbon black, graphene, etc.) and a binder. Typical binders include polyvinylidene fluoride (PVDF), polyethylene oxide (PEO), polyethylene (PE), polypropylene (PP), polytetrafluoroethylene (PTFE), polyacrylates, polyvinyl pyrrolidone, (PVP) poly(methyl methacrylate) (PMMA), copolymers of polyhexafluoropropylene and polyvinylidene fluoride, polyethyl acrylate, polyvinyl chloride (PVC), polyacrylonitrile (PAN), polycaprolactam, polyethylene terephthalate (PET), polybutadiene, polyisoprene or polyacrylic acid, or derivatives blends or copolymers thereof In some embodiments, a binder is water soluble binder, such as sodium alginate, or carageenan. Generally, binders hold active materials together and in intimate contact with a current collector (e.g., aluminum foil or copper foil, carbon paper or fabric).

In certain embodiments, cathode powder mixtures can be provided without a binder, which can be added during a manufacturing process to produce electrodes (e.g., as a solution or dispersion in water or a suitable carrier).

In some embodiments, a cathode mixture is ground, powdered or mixed to control properties of cathode powder (e.g. particle size) and to thoroughly mix ingredients. Such mixing can be performed by any means known in the art including but not limited to pin milling, hammer milling, jet milling, ball milling, air classifying, and combinations of these. Specific means used for mixing a powder will vary to suit a particular application, such as large scale production of cathode mixtures (e.g., production of drum quantities of powder for sale to cathode manufacturers).

Various materials for use in cathode mixtures are disclosed in Cathode Materials for Lithium Sulfur Batteries: Design, Synthesis, and Electrochemical Performance, Lianfeng, et al., Interchopen.com, Published Jun. 1, 2016 and The strategies of advanced cathode composites for lithium-sulfur batteries, Zhou et al., SCIENCE CHINA Technological Sciences, Volume 60, Issue 2: 175-185(2017), the entire disclosures of which are hereby incorporated by reference herein.

V. Electrode Compositions

There are a variety of methods for manufacturing electrodes for use in a LiS battery. One such process, referred to as a “wet process,” involves adding a positive active material (i.e., nanostructured materials), a binder and a conducting material (i.e., cathode mixture) to a liquid to prepare a slurry. Provided compositions are typically formulated into a viscous slurry in order to facilitate a downstream coating operation. A thorough mixing of a slurry can be critical for coating and drying operations, which will eventually effect performance and quality of electrodes. Appropriate slurry mixing devices include ball mills, magnetic stirrers, sonication, planetary mixers, high speed mixers, homogenizers, universal type mixers and static mixers. In some embodiments, a liquid may be any that effectively disperses positive active material, binder, conducting material, and any additives homogeneously, and is easily evaporated. Possible slurrying liquids include, for example, N-methylpyrrolidone, acetonitrile, methanol, ethanol, propanol, butanol, tetrahydrofuran, water, isopropyl alcohol, dimethylpyrrolidone and the like.

A prepared composition is coated on a current collector and dried to form a positive electrode. Specifically, a slurry is used to coat an electrical conductor to form an electrode by evenly spreading a slurry on to a conductor, which may then optionally be roll-pressed, calendared and heated as is known in the art. Generally, a dried slurry forms a matrix held together and adhered to a conductor by a polymeric binder included in a cathode mixture. In certain embodiments, a matrix comprises a lithium conducting polymer binder, such as polyvinylidene difluoride (PVDF), styrene butadiene rubber (SBR), polyethylene oxide (PEO), and polytetrafluoroethylene (PTFE). In certain embodiments, additional carbon particles, carbon nanofibers, carbon nanotubes, etc. are dispersed in a matrix to improve electrical conductivity. In some embodiments, lithium salts are dispersed in a matrix to improve lithium conductivity.

In some embodiments, a current collector is selected from the group consisting of: aluminum foil, copper foil, nickel foil, stainless steel foil, titanium foil, zirconium foil, molybdenum foil, nickel foam, copper foam, conductive carbon papers, sheets, or fabrics, polymer substrates coated with conductive metal, and/or combinations thereof.

In some embodiments, thickness of a matrix may range from a few microns to hundreds of microns (e.g., 2-200 microns). In some embodiment, a matrix has a thickness of about 10 to about 50 microns. Generally, increasing thickness of a matrix increases percentage of active materials to other cell constituents by weight, and in some embodiments, increases cell capacity. However, diminishing returns may be exhibited beyond certain thicknesses. In some embodiments, a matrix has a thickness of between about 5 and about 200 microns. In some such embodiments, a matrix has a thickness of between about 10 and about 100 microns.

In certain embodiments, a negative electrode (i.e., anode) contains a negative active material. In some embodiments, a negative active material is one that can reversibly release lithium ions. In some embodiments, a material may be lithium metal or a lithium composite with other materials such as carbon, tin, zinc, aluminum, titanium, silicon, and mixtures, alloys, or composites of any of these. Suitable carbon materials include crystalline carbon, amorphous carbon, graphitic carbon, graphene, carbon nanotubes, or a combination thereof. Other suitable materials, which can reversibly form a lithium-containing compound by reacting with the lithium or its ions, may include tin oxide (SnO₂), titanium nitrate, silicon (Si) and the like, but not limited thereto. Lithium metal may be present in pure form or alloyed. In some embodiments, lithium alloys include lithium and metal selected from the group consisting of: Na, K, Rb, Cs, Fr, Be, Mg, Ca, Sr, Ba, Zn, Al and Sn. Typically, a negative electrode may also contain negative active material disposed on a current collector, such as those described above.

PCT Publication Nos. WO2015/003184, WO2014/074150, and WO2013/040067, the entire disclosures of which are hereby incorporated by reference herein, described various methods of fabricating electrodes and electrochemical cells that are suitable to utilize nanostructured materials of the present disclosure.

VI. Electrochemical Cells

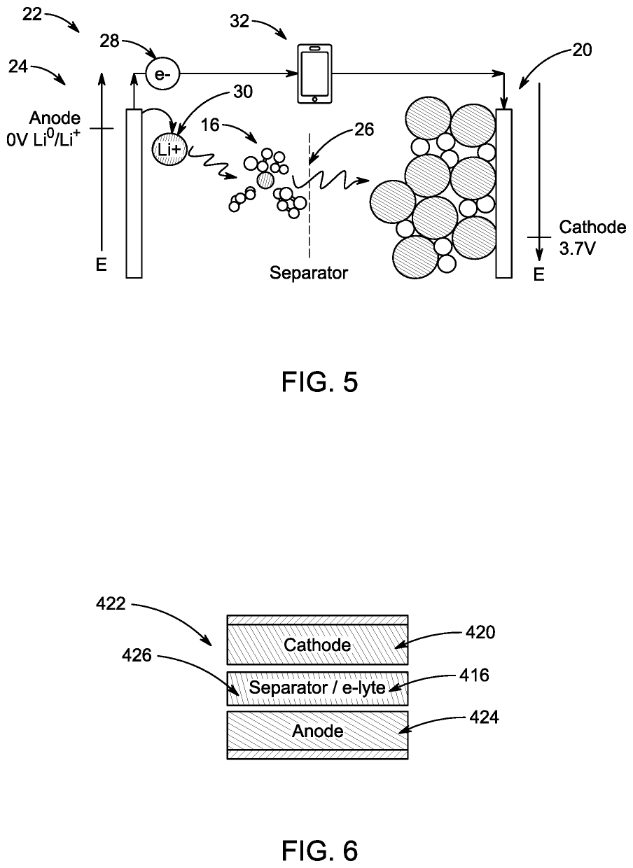

Generally, an electrochemical battery such as an Li/S battery comprises a stack of electrodes comprising a plurality of individual electrochemical cells. FIG. 6 shows a representative electrochemical cell 422 that can be used in an Li/S battery. Cell 422 is formed with a positive electrode (cathode 420), a negative electrode (anode 424), a separator 426 disposed between anode 424 and cathode 420, and an electrolyte 416. An electrolyte may be a solid, a liquid, or a gel electrolyte. In certain embodiments, where a liquid electrolyte is used, electrolyte is held in the pores of a porous separator 426, as well as in pores in cathode 420 and anode 424 if these are porous structures. These cells 422 can be used for a variety of batteries or other electrochemical energy storage devices. Electrochemical cells disclosed herein can be substituted in place of, or used in conjunction with, conventional electrodes for lithium-sulfur batteries or other types of batteries. Number of cells 422 and their specific configuration can vary to suit a particular application. Operation of an electrochemical cell is described below with respect to FIG. 5.

VII. Methods

In another aspect, the present disclosure encompasses methods to make and use nanostructured materials comprising covalently cross-linked conductive polymers. In certain embodiments, such methods are used to “tune” or otherwise enhance a property or characteristic of nanostructures, such as by controlling strength, elasticity, or conductivity of CCP (e.g., via identity or density of cross-linking) to suit a particular application. By enhancing such characteristics of the nanostructured materials, the energy density or performance of an electrochemical device comprising a nanostructure is improved, in some instances, as discussed below.

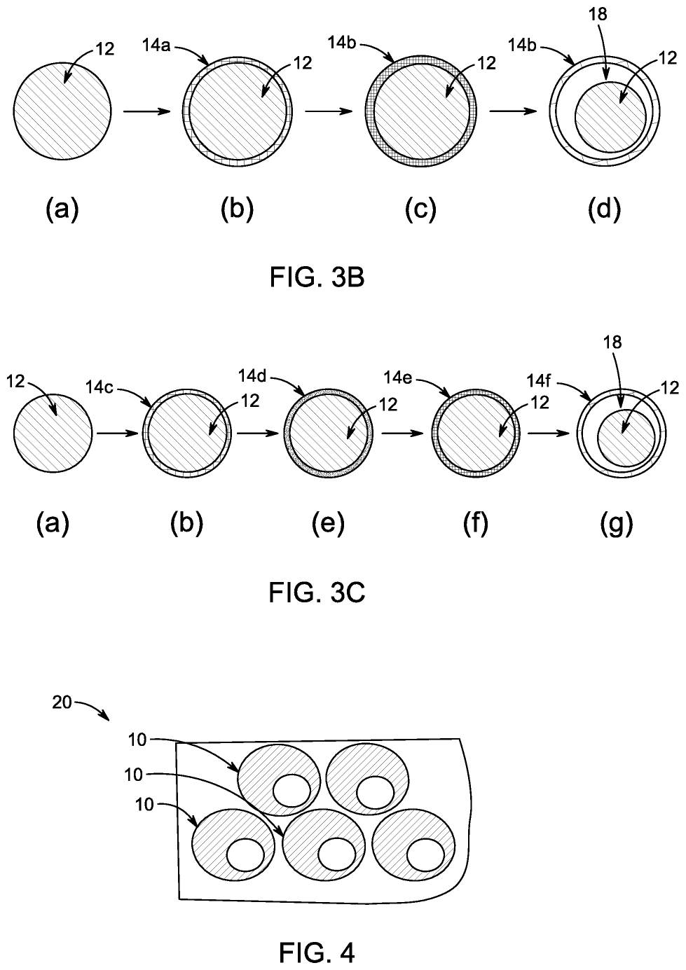

FIGS. 3A through 3C depict various methods of manufacturing core-shell and yolk-shell nanoparticles in accordance with one or more embodiments of the present disclosure.

FIG. 3A depicts a process of making core-shell and yolk-shell nanoparticles according to the embodiments of the present disclosure comprising formation of CCP compositions during polymerization. Starting condition (a), a sulfur-containing nanoparticle 12 is provided (this can comprise any of provided electroactive sulfur-containing materials or mixtures described hereinabove). Provided sulfur-containing nanoparticle is contacted with a polymerization mixture comprising a mixture of difunctional monomers in combination with a proscribed molar ratio of one or more tri- or higher-functional co-monomers under conditions that promote polymerization to produce a conductive polymer (e.g., any of provided conductive polymer compositions described hereinabove). This produces a core-shell nanoparticle depicted in (b), wherein sulfur-containing nanoparticle 12 is surrounded by a CCP shell 14. This core-shell particle can itself, have utility in formulation of cathode mixtures and manufacture of electrochemical devices, or it can be further processed to remove a portion of a sulfur-containing core thereby forming a yolk-shell particle shown in (c) where CCP shell 14 now surrounds a smaller sulfur-containing nanoparticle 12b and a void space 18.

In certain embodiments, a process, such as depicted in FIG. 3A, is used to produce core-shell and yolk-shell sulfur nanoparticles with cross-linked PAni shells. For example, a process depicted in FIG. 3A, comprises steps of: providing an elemental sulfur nanoparticle 12; suspending sulfur nanoparticle 12 in a dilute aqueous acid solution (e.g. dilute sulfuric acid) containing aniline, triphenylamine, and p-phenylene diamine; adding to a suspension an oxidant (e.g. potassium peroxidisulfate); and stirring a mixture for a period of time sufficient to form cross-linked polyaniline, resulting in formation of core-shell nanoparticles as shown in (b) which comprise an elemental sulfur core 12 surrounded by a cross-linked PAni shell 14. In certain embodiments, cross-linked PAni coated sulfur core-shell nanoparticle depicted in (b) is isolated and then heated under vacuum to remove a portion of an elemental sulfur core to provide a yolk-shell nanoparticle comprising a cross-linked PAni shell 14, surrounding a sulfur containing yolk 12b, and a void space 18 as shown in (c). Alternatively, a cross-linked PAni coated sulfur core-shell nanoparticle depicted in (b) is isolated and then extracted with a solvent such as toluene or carbon disulfide that is capable of dissolving sulfur to provide a yolk-shell particle. Alternatively, a cross-linked PAni coated sulfur core-shell nanoparticle depicted in (b) is treated in situ with a solvent such as toluene or carbon disulfide that is capable of dissolving sulfur to provide a yolk-shell particle after polymerization.

FIG. 3B depicts a process of making core-shell and yolk-shell nanoparticles according to embodiments of the present disclosure where a conductive polymer is cross-linked in a post-polymerization process. At starting condition (a), a sulfur-containing nanoparticle 12 is provided (this can comprise any of provided electroactive sulfur-containing materials or mixtures described hereinabove). Provided sulfur-containing nanoparticle is treated under conditions that cause nanoparticle 12 to be coated with a conductive polymer (e.g., any of provided conductive polymer compositions described hereinabove). In some embodiments, a core can be coated either by contacting it with monomers under conditions that promote polymerization or by contacting it with pre-formed polymer under conditions that cause a sulfur-nanoparticle to be coated in a polymer such as solution coating, spray drying, etc. Either process leads to a core-shell nanoparticle such as depicted in (b), wherein sulfur-containing nanoparticle 12 is surrounded by a conductive polymer shell 14a. (In contrast to process of FIG. 3A, a polymer shell 14a may or may not comprise cross-links formed during polymerization). In certain embodiments, a core-shell particle is then treated with a cross-linking reagent to provide core-shell nanoparticle shown (c) which comprises a sulfur-containing core 12, surrounded by a cross-linked conductive polymer 14b. In some embodiments, a core-shell particle itself has utility in formulation of cathode mixtures and manufacture of electrochemical devices; in some embodiments, a core-shell particle can be further processed to remove a portion of a sulfur-containing core thereby forming a yolk-shell particle shown in (d) where a cross-linked conductive polymer shell 14b now surrounds a smaller sulfur-containing nanoparticle 12b and a void space 18.

In some embodiment, a process such as depicted in FIG. 3B is used to produce core-shell and yolk-shell sulfur nanoparticles with cross-linked PAni shells. For example, in some embodiments, a method according to a process depicted in FIG. 3B comprises steps of: providing an elemental sulfur nanoparticle 12; suspending sulfur nanoparticle 12 in a dilute aqueous acid solution (e.g. dilute sulfuric acid) of aniline; adding to said suspension an oxidant (e.g., potassium peroxidisulfate); and stirring said mixture for a period of time sufficient to form polyaniline. This results in formation of a core-shell nanoparticle as shown in (b) which comprises an elemental sulfur core 12 surrounded by a PAni shell 14a. This PAni-coated particle is optionally isolated and then contacted with crosslinking agent glutaraldehyde in a proscribed molar ratio relative to aniline units in a PAni shell in the presence of a dehydrating reagent (or under dehydrating reaction conditions) to provide nanoparticle in (c) which comprises a covalently cross-linked PAni shell 14b, surrounding a sulfur-containing core 12. This core-shell particle can be treated as described above with respect to FIG. 3A, to remove a portion of a sulfur core and create a yolk-shell nanoparticle.

Similarly, PAni-coated particle 14a may be contacted with a diisocyanate (e.g. toluene diisocyanate (TDI), methylene diphenyl isocyanate (MDI), or hexamethylene diisocyanate (HDI)) in a proscribed molar ratio relative to aniline units in its PAni shell. This may optionally be performed in the presence of suitable catalyst to provide a nanoparticle in PAni which comprises a covalently cross-linked Pani shell 14b, surrounding sulfur-containing core 12. In some embodiments, this core-shell particle is further treated as described above with respect to FIG. 3A, to remove a portion of sulfur core 12 and create a yolk-shell nanoparticle.

FIG. 3C depicts a process of making core-shell and yolk-shell nanoparticles according to embodiments of the present disclosure where a conductive polymer is cross-linked in a post-polymerization process and where properties of a crosslinked shell are modulated by changing doping state of a polymer comprising shell prior to cross-linking. Starting at (a), a sulfur-containing nanoparticle 12 is provided (this can comprise any of provided electroactive sulfur-containing materials or mixtures described hereinabove). Provided sulfur-containing nanoparticle 12 is treated under conditions that cause it to be coated with a conductive polymer (e.g. any of provided conductive polymer compositions described hereinabove). In some embodiments, a core can be coated either by contacting it with monomers under conditions that promote polymerization or by contacting it with pre-formed polymer under conditions that cause a sulfur-nanoparticle to be coated in polymer. Either process leads to a core-shell nanoparticle depicted in (b), wherein sulfur-containing nanoparticle 12 is surrounded by a conductive polymer shell 14c comprising a conductive polymer in a first doped state. In some embodiments, a core-shell particle is treated under conditions to change doping state of a conductive polymer (e.g., if shell 14c comprises an un-doped polymer, it may be doped, or if it comprises a doped polymer, it may be partially or wholly de-doped or treated with a reagent to change dopant identity) to provide a core-shell nanoparticle shown at (c) which comprises a sulfur-containing core 12, surrounded by a shell 14d comprising a polymer with a doping state different from that of polymer in shell 14c. In some embodiments, a core-shell particle is then treated with a cross-linking reagent to provide a core-shell nanoparticle shown in (d) which comprises a sulfur-containing core 12, surrounded by a cross-linked conductive polymer shell 14e. In some embodiments, a core-shell particle itself has utility in formulation of cathode mixtures and manufacture of electrochemical devices, or in some embodiments, a core-shell particle is further processed to remove a portion of a sulfur-containing core thereby forming a yolk-shell particle shown in (e) where a cross-linked conductive polymer shell 14e now surrounds a smaller sulfur-containing nanoparticle 12b and a void space 18.

In some embodiments, a process such as depicted in FIG. 3C is used to produce core-shell and yolk-shell sulfur nanoparticles with cross-linked PAni shells. For example, in some embodiments, a method according to a process such as depicted in FIG. 3C comprises steps of: providing an elemental sulfur nanoparticle 12; suspending sulfur nanoparticle 12 in a dilute sulfuric acid solution of aniline; adding to said suspension an oxidant (e.g. potassium peroxydisulfate); and stirring said mixture for a period of time sufficient to form polyaniline. This results in formation of a core-shell nanoparticle as shown in (b) that comprises an elemental sulfur core 12 surrounded by a sulfate-doped PAni shell 14c. By way of illustration of several different variations of this process, these particles are divided into three portions. A first portion is set aside as formed, a second portion is treated with aqueous ammonia and rinsed with distilled water until the wash has a neutral pH to provide a sample with a de-doped polymer shell, and a third portion is treated with ammonia in a similar fashion and suspended in a concentrated solution of 4-dodecylbenzene sulfonic acid (DBSA) before being rinsed and isolated. This leads to core-shell particles containing un-crosslinked PAni chains that are doped with sulfate, undoped, or doped with DBSA. Each of these samples is then treated separately with glutaraldehyde at a proscribed molar ratio relative to aniline units in PAni shells in the presence of a dehydrating reagent to provide three nanoparticle compositions: a first sample according to a process of FIG. 3B that comprises core-shell sulfur nanoparticles with cross-linked sulfate-doped PAni shells, a second sample according a process of FIG. 3C that comprises core-shell sulfur nanoparticles that comprises core-shell sulfur nanoparticles with DBSA-doped cross-linked PAni shells, and a third sample that comprises core-shell sulfur nanoparticles with un-doped cross-linked PAni shells. Provided processes allow nanoparticles with different characteristics to be prepared and allow optimization of performance characteristics of the nanoparticles through independent control of doping state, identity of a cross-linking agent, and density of cross-linking, each of which can be modulated to change performance properties of core-shell nanoparticles.

In processes depicted in FIGS. 3A through 3C, a step of converting a core-shell nanoparticle to a yolk-shell nanoparticle can encompass any means of achieving desired reduction in volume of an electroactive core. In certain embodiments, such means may include: i) treating a core-shell nanoparticle with vacuum and/or heat or vaporize a portion of a sulfur-containing core; ii) treating a core-shell nanoparticle with a solvent to dissolve a portion of a sulfur-containing core; iii) treating a core-shell nanoparticle with a chemical reagent to react with and decompose a portion of a sulfur-containing core; iv) treating a composite sulfur-containing core with a solvent or reagent that dissolves or reacts with a portion of a composite; and v) combinations of any two or more of these. In certain embodiments, a core-shell particle is formed in a state where an electroactive sulfur-containing core has a maximum volume during a change of volumes resulting from changes in charge state of an electroactive material. An example would be where an initially-formed core-shell particle (e.g., that shown in FIG. 3A (b), FIG. 3B (c) or FIG. 3C (f)) comprises an alkali metal sulfide such as Li₂S or Na₂S. In these embodiments, conversion from a core-shell structure to a yolk-shell structure would be effected by electrochemically converting a core to a more oxidized sulfur compound (e.g. S8, or a polysulfide) with a lower molar volume. In certain embodiments, this step is performed during manufacture of the core-shell nanoparticles, or during a subsequent step required to manufacture or to use an electrochemical device incorporating core-shell particles. For example, transformation from a core-shell particle to a yolk-shell particle could take place during charging of a manufactured battery incorporating provided core-shell particle in a cathode composition.

Various methods of doping, de-doping and chemical cross-linking of conductive polymers are disclosed in “Polyaniline Membranes for Use in Organic Solvent Nanofiltration” by Xun Xing Loh, Dept. of Chemical Engineering and Chemical Technology Imperial College of London, April 2009, the entire disclosure of which is incorporated by reference herein.

In embodiments where cross-linking occurs in a post-polymerization process, functional groups can be incorporated into polymer chains and undergo reaction in a post-polymerization process to create covalent linkages between polymer chains. In some embodiments, olefin moieties are incorporated (e.g., on a functionalized co-monomer) followed by post-polymerization olefin metathesis. Alternatively or additionally, functional groups, such as alcohols, acids, esters, epoxides, aldehydes, anhydrides, azides, alkynes, etc., are incorporated and followed by post-polymerization reactions of functional groups to form inter-chain linkages including esters, ethers, urethanes, acetals, triazole, and the like. See, for example, Functional Polymers by Post-Polymerization Modification: Concepts, Guidelines and Applications, Theato et al., John Wiley and Sons, 2013 (Online ISBN:9783527655427), the entire disclosure of which is hereby incorporated by reference herein.

FIG. 4 depicts one possible arrangement of nanoparticles to create an electrode 20, such as a cathode. Generally, cathode 20 is made up of a plurality of nanoparticles 10 that, in some embodiments, take the form of sheets or foils, wires, or other agglomerations of encapsulated structures combined with one or more suitable binders (see, for example, FIGS. 2A-2C).

FIG. 5 depicts one possible electro-chemical cell 22 that, in some embodiments, is used to manufacture a battery in accordance with one or more embodiments of the present disclosure. Cell 22 is depicted during a discharge operation. Cell 22 includes an anode 24 made up of a lithium-based material, a cathode 20 made up of provided nanoparticles disclosed herein, a separator 26, and an electrolyte 16. During discharge operation, lithium-based material of an anode (a high potential energy state) is oxidized, generating an electron 28 and a lithium ion 30. Electron 28 performs work in an external circuit 32, while lithium ion 30 passes through separator 26 and recombines with electron 28 in cathode 28 (a lower potential energy state). Electrolyte 16 acts as a medium for lithium ions 30 to move within a cell and to passivate a reactive anode surface (e.g. a protective “Solid Electrolyte Interphase” (SEI)).

During charging, specifically recharging, lithium ions 30 move back through electrolyte 16 towards anode 24, and electrons 28 travel back through external circuit 32. Typically, cathode active materials that have dissolved into electrolyte, such as polysulfides form insoluble solids that lead to anode and cathode fouling and reduced capacity and slower charging. Using nanoparticles described herein, specifically CCP shells, helps to retain sulfur in a cathode to reduce or eliminate migration of polysulfides into bulk electrolyte 16.

In some embodiments, use of a “tuned” shell reduces sulfur loss, thereby mitigating battery decay and providing for higher energy densities. Specifically, this results in greater utilization of sulfur active material (energy density) and enhanced kinetics (power density). Energy density is measured in watt-hours per kilogram (Wh/kg) and refers to an amount of energy a battery can store with respect to its mass. Power density is measured in watts per kilogram (W/kg) and refers an amount of power that can be generated by a battery with respect to its mass.

While the present disclosure has been primary described with respect to polyaniline-based shells, alternative categories of conductive polymers are contemplated and considered within the scope of the present disclosure. Such alternatives include polymers, such as polydopamine, polypyrrole, polyselenophene, polythiophene, polynaphthalene, polyphenylene sulfide, and derivatives, mixtures or copolymers of any of these. In certain embodiments, CCPs of the present disclosure comprise polymers selected from the group consisting of: polypyrrole (PPy), polythiophene (PTh), polydopamine, poly(3,4-ethylenedioxythiophene) (PEDOT), poly(3,4-propylenedioxythiophene) (ProDOT), poly(3,4-ethylenedioxypyrrole) (PEDOP), poly(3,4-propylenedioxypyrrole) (ProDOP), poly(3,4-ethylenedithiopyrrole) (PEDTP), poly(3,4-ethyleneoxyhiathiophene) (PEOTT), poly(3,4-ethylenedioxyselenophene) (PEDOSe), and derivatives, mixtures or copolymers of any of these. In certain embodiments, CCPs of the present disclosure comprise polymers selected from the group consisting of: polyaniline (PAni), poly(o-methylaniline) (POTO), poly(o-methoxyaniline) (POAS), poly(2,5-dimethylaniline) (PDMA), poly(2,5-dimethoxyaniline) (PDOA), sulfonated polyaniline (SPAN), poly(1-aminonaphthalene) (PNA), poly(5-aminonaphthalene-2-sulfonic acid), polyphenylene sulfide, and derivatives, mixtures or copolymers of any of these.

CCP shells are preferably conductive within the operating voltage range of Li/S batteries (e.g., 1.5-2.4 V). In certain embodiments, CCP shells are conductive within a voltage range outside the operating voltage range of Li/S batteries (e.g., 1.5-2.4 V). In certain embodiments, CCP shells are conductive to lithium ions. In certain embodiments, CCP shells are electronic semiconductors, but are conductive to lithium ions. In certain embodiments, CCP shells are electronically insulating, but are conductive to lithium ions. For structures of additional conductive polymers, refer to Synthesis, processing and material properties of conjugated polymers, Polymer, Vol. 37, No. 22, pp. 5017-5047, 1996, the entire disclosure of which is incorporated by reference herein.

### EXAMPLES

Example 1. Formation of core-shell nanoparticles with conductive covalently cross-linked PAni shells formed via cross-linking during polymerization.

Sulfur nanoparticles (1 g) were dispersed in an aqueous solution of polyvinylpyrrolidone (PVP) (1 wt. %, 805 mL) and combined with DI water (85 mL) and 1M sulfuric acid (60 mL). Aniline (395 μL, 4.4 mmol), triphenylamine (11.5 mg, 0.05 mmol), and p-phenylenediamine (9.6 mg, 0.09 mmol) were charged and the mixture was cooled in an ice bath. The reaction was sparged with nitrogen for 30 min and an aqueous solution of ammonium persulfate solution (50 mL, 0.2M) was added dropwise over 30 min. The reaction was stirred, under nitrogen, at 0° C. and allowed to warm to room temperature over 17 h. The reaction solids were isolated by centrifugation, washed twice with DI water, and dried for 4 hours (h) to produce a charcoal gray powder.

Example 2. Formation of covalently cross-linked yolk-shell nanoparticles. The reaction solids from Example 1 are suspended in ethanol and a calibrated amount of toluene is added. The mixture is stirred and aliquots of the solvent are filtered and analyzed by combustion analysis each hour until the dissolved sulfur in solution corresponds to 25% of the sulfur contained in the starting material. The products are isolated by centrifugation, washed twice with DI water and dried to produce a gray powder.

Example 3. Formation of covalently cross-linked core-shell nanoparticles with conductive cross-linked polymer shells with higher cross-link density.

A reaction was performed as in Example 2, except the monomer ratios were adjusted to: aniline (336 μL, 3.7 mmol)), triphenylamine (66 mg, 0.27 mmol), and p-phenylenediamine (58 mg, 0.54 mmol) for the coating polymerization.

Example 5. Core-shell sulfur nanoparticles with PAni shells cross-linked by post-polymerization reaction with glutaraldehyde.

Sulfur nanoparticles (1 g) were dispersed in an aqueous solution of polyvinylpyrrolidone (PVP) (1 wt. %, 805 mL). The sulfur dispersion was combined with DI water (85 mL) and 1 M sulfuric acid (60 mL). The mixture was cooled in an ice bath and sparged with nitrogen for 30 min. Aniline (0.41 mL, 4.5 mmol) was charged followed by the dropwise addition of an aqueous solution of ammonium persulfate (50 mL, 0.2 M) over 30 min. The reaction was stirred, under nitrogen, at 0° C. and allowed to warm to room temperature over 17 h. The reaction solids were isolated by centrifugation, washed twice with DI water, and dried for 4 h to produce a dark green powder.

The powder is suspended in 120 mL of a solution consisting of 10 mL of glutaraldehde (GA) (50 wt. % aqueous solution) and 10 mL of conc. HCl (12 M) in deionized water at room temperature. After 0.5 h, 80 mL of acetone is added to facilitate crosslinking. The final concentration of GA in the cross-linker solution is 0.3 M in acetone/water solution (40/60 v/v %) and the concentration of HCl is 0.5 M. Approximately 10 molar excess of GA (with respect to PAni) is used. The particles are allowed to stand in the cross-linker solution for 5 days. After crosslinking, the particles are washed with DI water and isolated by centrifugation.

Example 5b. Core-shell sulfur nanoparticles with PAni shells cross-linked by post-polymerization reaction with diisocyanate.

Sulfur nanoparticles were coated with polyaniline as in Example 5. The resulting powder is suspended in 10 mL of a N-methylpyrrolidone to which is added 0.10 g of toluene diisocyanate and 5 mg of dibutyltin dilaurate. After 4 h, the mixture is filtered, the particles washed with N-methylpyrrolidone followed by DI water and isolated by centrifugation.

Example 6. Core-shell sulfur nanoparticles with PAni shells cross-linked by post-polymerization reaction with glutaraldehyde with modification to the doping state of PAni. The process according to Example 5 is followed, except prior to reaction with glutaraldyde, the core-shell particles are suspended in 10% aqueous ammonia for 6 h to de-dope the polymer shells, then rinsed and centrifuged.

Example 6b. The process according to Example 6 is followed, except after de-doping, and before reaction with glutaraldehyde, the nanoparticles are suspended in a 100 mM solution of DBSA.

It is contemplated that compositions, systems, devices, methods, and processes of the present application encompass variations and adaptations developed using information from the embodiments described in the present disclosure. Adaptation or modification of the methods and processes described in this specification may be performed by those of ordinary skill in the relevant art.

Throughout the description, where compositions, compounds, or products are described as having, including, or comprising specific components, or where processes and methods are described as having, including, or comprising specific steps, it is contemplated that, additionally, there are articles, devices, and systems of the present application that consist essentially of, or consist of, recited components, and that there are processes and methods according to the present application that consist essentially of, or consist of, recited processing steps.

It should be understood that order of steps or order for performing certain action is immaterial so long as a described method remains operable. Moreover, two or more steps or actions may be conducted simultaneously.

What is claimed:

1. A nanoparticle comprising:
a conductive polymer shell; and
an electroactive core disposed within the shell,
wherein the polymer shell comprises a covalently cross-linked polymer.

2. The nanoparticle of claim 1, wherein at least one characteristic of the polymer shell is optimized by the covalently cross-linked conductive polymer as compared to a polymer shell that does not comprise the covalently cross-linked polymer.

3. The nanoparticle of claim 1 or 2, wherein the polymer shell is electronically conductive at or below about 2.4 volts.

4. The nanoparticle of claim 1 or 2, wherein the polymer shell is conductive within the range of about 1.5 to about 2.4 volts.

5. The nanoparticle of any one of the preceding claims, wherein the polymer shell defines a cavity having an interior volume, and wherein the electroactive core comprises about 20% to about 80% of the cavity's interior volume.

6. The nanoparticle of any one of the preceding claims, wherein the polymer shell is cross-linked with a polyfunctional monomer.

7. The nanoparticle of any one of the preceding claims, wherein the polymer shell comprises covalently cross-linked polyaniline.

8. The nanoparticle of any one of the preceding claims, wherein the polymer is selected from the group consisting of a polyaniline, a polyheterocycle, a poly-ene, or a polyarene.

9. The nanoparticle of claim 2, wherein the at least one characteristic of the shell includes at least one of mechanical strength, elasticity, conductivity, solubility, swellability or the ability to prevent polysulfide shuttling.

10. The nanoparticle of any one of the preceding claims, wherein cross-linking of the covalently cross-linked conductive polymer occurs during polymerization of the shell.

11. The nanoparticle of claim 10, wherein cross-linking occurs between multivalent co-monomers during polymer synthesis.

12. The nanoparticle of claim 11, wherein triphenylamine or paraphenylene diamine are incorporated as co-monomers during polymer synthesis.

13. The nanoparticle of any one of claims 1 to 9, wherein cross-linking of the covalently cross-linked conductive polymer occurs in a post-polymerization process.

14. The nanoparticle of claim 13, wherein cross-linking occurs between functional groups located on co-monomers introduced during polymer synthesis.

15. The nanoparticle of any one of the preceding claims, wherein the covalently cross-linked conductive polymer comprises an inter-polymer chain cross-linker.

16. The nanoparticle of claim 15, wherein the cross-linker is formed when a suitable cross-linking agent reacts with two or more polymer chains to form one or more covalent bonds.

17. The nanoparticle of any one of claims 1 to 16, wherein the covalent bonds formed are not by a sulfur atom.

18. The nanoparticle of claim 16, wherein the cross-linker does not comprise sulfur atoms.

19. The nanoparticle of any one of the preceding claims, wherein the shell has a dimension of about 20 to about 1,000 nm.

20. The nanoparticle of any one of the preceding claims, wherein the shell has a wall thickness of about 5 to about 50 nm.

21. The nanoparticle of any one of the preceding claims, wherein the nanoparticle has a substantially spherical shape.

22. The nanoparticle of any one of the preceding claims, wherein the shell comprises two or more layers.

23. The nanoparticle of claim 22, wherein the two or more layers comprise different compositions.

24. An electrode for an electrochemical energy storage device, the electrode comprising a nanoparticle in accordance with any one of the preceding claims.

25. An electrochemical energy storage device comprising:
an anode;
a cathode comprising:
a plurality of nanoparticles in accordance with any one of claims 1 to 23;
a separator; and
an electrolyte.

26. A powder for use in making an electrode, the powder comprising a mixture of nanoparticles in accordance with any one of claims 1 to 24 and electrically conductive particles.

27. The powder of claim 26, wherein the mixture further comprises a binder.

28. The powder of claim 26 or 27, wherein the mixture is homogenous.
